(19) United States
(12) Patent Application Publication
(10) Pub. No.: US 2013/0208089 A1
(43) Pub. Date: Aug. 15, 2013

(54) TRANSMITTER, RECEIVER, COMMUNICATION SYSTEM, AND DISPLAY CONTROL METHOD

(71) Applicants: Yoshitomo Akagi, Osaka-shi (JP); Akiko Uehara, Osaka-shi (JP)

(72) Inventors: Yoshitomo Akagi, Osaka-shi (JP); Akiko Uehara, Osaka-shi (JP)

(73) Assignee: SHARP KABUSHIKI KAISHA, Osaka-shi, Osaka (JP)

(21) Appl. No.: 13/879,739

(22) PCT Filed: Oct. 17, 2011
(86) PCT No.: PCT/JP2011/073799

§ 371 Date: Apr. 16, 2013

(30) Foreign Application Priority Data
Oct. 19, 2010 (JP) 2010-234567

(51) Int. Cl. H04N 13/00

(52) U.S. Cl. CPC H04N 13/0059
USPC 348/43

(57) ABSTRACT

A transmitter is provided by which switching between two-dimensional display and three-dimensional display can be associated with data communication. When receiving a command for transmitting transmission data, a processor of the transmitter starts a process to transmit the transmission data to a receiver using a communication IF. When starting the process, the processor two-dimensionally displays an object on a display. After two-dimensionally displaying the object, the processor three-dimensionally displays the object on the display. During the three-dimensional display, the processor increases a stereoscopic amount of the object on the display with passage of time.

### TECHNICAL FIELD

The present invention relates to a transmitter, a receiver, a communication system, a display control method, and a program. The present invention particularly relates to a transmitter and a receiver each capable of two-dimensional display and three-dimensional display; a communication system including the transmitter and the receiver; a display control method in each of the transmitter and the receiver; and a program for controlling the transmitter and the receiver.

### BACKGROUND ART

Conventionally, a device capable of displaying a two-dimensional image and a three-dimensional image has been known.

As such a device, Patent Document 1 (Japanese Patent Laying-Open No. 2004-328566) discloses a content display device. The content display device is capable of switching between two-dimensional display and three-dimensional display. When switching from a two-dimensional image to a three-dimensional image, the content display device first switches a display state in a display unit to the three-dimensional display, and thereafter gradually increases parallax of content data with a predetermined switching time.

Patent Document 2 (Japanese Patent Laying-Open No. 10-172004) discloses a stereoscopic image display method as a display method in a device capable of displaying a two-dimensional image and a three-dimensional image. In this stereoscopic image display method, a right-eye image and a left-eye image are separately provided to the right eye and the left eye to reproduce a stereoscopic image. Further, in the stereoscopic image display method, the two images for the left eye and the right eye are generated by a computer using three-dimensional computer graphics in which a captured image is generated in accordance with information describing a three-dimensional space. Further, in the stereoscopic image display method, by changing a parallax amount of the two images for the left eye and the right eye, transition can be made between a non-stereoscopic display state and a stereoscopic display state.

Meanwhile, a device capable of transferring data has been conventionally known.

As such a device, Patent Document 3 (Japanese Patent Laying-Open No. 2006-340237) discloses an image processing device that transfers image data. The image processing device obtains a representative image of transfer target image data, and displays a representative image, which corresponds to a transfer state of the transfer target image data, on a display unit of the image processing device.

As the device capable of transferring data, Patent Document 4 (Japanese Patent Laying-Open No. 2004-96329) discloses an electronic camera that transfers image data obtained by image capturing. While operating to transfer the image data, on a display monitor provided in the electronic camera, the electronic camera displays images together with a frame for image not transferred, a frame for image currently transferred, and a frame for transferred image. Each of the frames indicates a transfer state. The frame for image not transferred is displayed for an image that has not been transferred yet. The frame for image currently transferred is displayed for an image that is currently being transferred. The frame for transferred image is displayed for an image that has been already transferred.

As the device capable of transferring data, Patent Document 5 (Japanese Patent Laying-Open No. 2007-300288) discloses a multifunction peripheral. This multifunction peripheral displays an animation, which represents a currently performed operation, on a display panel so as to allow a user to select an operation to be canceled by touching the displayed animation.

It has been also conventionally known to use icon display to indicate that data transfer is currently being performed, or to use a bar to indicate a data transfer state.

### CITATION LIST

### Patent Document

PTD 1: Japanese Patent Laying-Open No. 2004-328566

PTD 2: Japanese Patent Laying-Open No. 10-172004

PTD 3: Japanese Patent Laying-Open No. 2006-340237

PTD 4: Japanese Patent Laying-Open No. 2004-96329

PTD 5: Japanese Patent Laying-Open No. 2007-300288

### SUMMARY OF INVENTION

### Technical Problem

Although Patent Document 1 discloses the switching between the two-dimensional display and the three-dimensional display, Patent Document 1 is directed to a technique for a single device. Hence, the content display device of Patent Document 1 is not capable of switching between the two-dimensional display and the three-dimensional display based on a relation with other device(s).

Meanwhile, the stereoscopic image display method of Patent Document 2 is implemented by a configuration including a stereoscopic image display device serving as a display, a computer, and an input device. Thus, also in the stereoscopic image display method, the switching between the two-dimensional display and the three-dimensional display cannot be made based on a relation with other device(s).

Further, each of Patent Documents 3 to 5, which disclose techniques regarding data transfer, does not disclose a technique regarding the switching between the two-dimensional display and the three-dimensional display.

The present invention has been made in view of the foregoing problem and has its object to provide a transmitter, a receiver, a communication system, a display control method, and a program, by each of which the switching between the two-dimensional display and the three-dimensional display can be associated with data communication.

### Solution to Problem

In accordance with an aspect of the present invention, a transmitter includes a processor, a memory connected to the processor, a display, and a communication interface. Transmission data and image data for displaying an object are stored in the memory. The image data includes right-eye image data and left-eye image data for three-dimensionally displaying the object. When receiving a command for transmitting the transmission data, the processor starts a process to transmit the transmission data to a receiver using the communication interface. When starting the process, the processor displays the object on the display based on the image data in predetermined one display manner of two-dimensional display and three-dimensional display. After displaying the object in the one display manner, the processor displays the object on the display in a different display manner of the two-dimensional display and the three-dimensional display than the one display manner.

In accordance with another aspect of the present invention, a transmitter includes a processor, a memory connected to the processor, a display, and a communication interface. Transmission data and image data for displaying an object are stored in the memory. The image data includes right-eye image data and left-eye image data for three-dimensionally displaying the object. The processor displays the object on the display based on the image data in predetermined one display manner of two-dimensional display and three-dimensional display. When receiving a command for transmitting the transmission data with the object being displayed on the display, the processor starts a process to transmit the transmission data to a receiver using the communication interface. When starting the process, the processor displays the object on the display in a different display manner of the two-dimensional display and the three-dimensional display than the one display manner.

Preferably, during the three-dimensional display, the processor changes a stereoscopic amount of the object on the display with passage of time.

Preferably, the predetermined one display manner is the two-dimensional display. The processor increases the stereoscopic amount of the object with passage of time.

Preferably, the predetermined one display manner is the three-dimensional display. The processor decreases the stereoscopic amount of the object with passage of time.

Preferably, the processor further transmits the image data to the receiver.

Preferably, when starting the process to transmit the transmission data to the receiver, the processor changes the stereoscopic amount of the object while moving the object in a predetermined direction.

Preferably, when the transmission of the transmission data is completed, the processor stops displaying the object.

In accordance with still another aspect of the present invention, a receiver includes a processor, a memory connected to the processor, a display, and a communication interface. The processor receives transmission data, which is transmitted from a transmitter, using the communication interface. When starting to receive the transmission data, the processor displays an object on the display in predetermined one display manner of two-dimensional display and three-dimensional display based on image data stored in the memory and including right-eye image data and left-eye image data. After displaying the object in the one display manner, the processor displays the object on the display in a different display manner of the two-dimensional display and the three-dimensional display than the one display manner.

Preferably, during the three-dimensional display, the processor changes a stereoscopic amount of the object on the display with passage of time.

Preferably, the predetermined one display manner is the three-dimensional display. The processor decreases the stereoscopic amount of the object with passage of time.

Preferably, the predetermined one display manner is the two-dimensional display. The processor increases the stereoscopic amount of the object with passage of time.

Preferably, the processor further receives the image data from the transmitter and stores the received image data in the memory.

Preferably, the memory has the image data stored therein in advance prior to the communication with the transmitter.

Preferably, when receiving the transmission data from the transmitter, the processor changes the stereoscopic amount of the object while moving the object in a predetermined direction.

In accordance with yet another aspect of the present invention, a communication system includes a first communication device and a second communication device. The first communication device includes a first processor, a first memory connected to the first processor, a first display, and a first communication interface. The second communication device includes a second processor, a second memory connected to the second processor, a second display, and a second communication interface. Transmission data and first image data for displaying a first object are stored in the first memory. The first image data includes right-eye image data and left-eye image data for three-dimensionally displaying the first object. When receiving a command for transmitting the transmission data, the first processor starts a process to transmit the transmission data to the second communication device using the first communication interface. When starting the process, the first processor displays the first object on the first display based on the first image data in a first display manner, which is predetermined one display manner of two-dimensional display and three-dimensional display. After displaying the first object in the first display manner, the first processor displays the first object on the first display in a different display manner of the two-dimensional display and the three-dimensional display than the first display manner. The second processor receives the transmission data from the first communication device using the second communication interface. When starting to receive the transmission data, the second processor displays a second object on the second display in a second display manner, which is predetermined one display manner of the two-dimensional display and the three-dimensional display, based on second image data stored in the second memory and including right-eye image data and left-eye image data. After displaying the second object in the second display manner, the second processor displays the second object on the second display in a different display manner of the two-dimensional display and the three-dimensional display than the second display manner.

In accordance with still another aspect of the present invention, a communication system includes a first communication device and a second communication device. The first communication device includes a first processor, a first memory connected to the first processor, a first display, and a first communication interface. The second communication device includes a second processor, a second memory connected to the second processor, a second display, and a second communication interface. Transmission data and first image data for displaying a first object are stored in the first memory. The first image data includes right-eye image data and left-eye image data for three-dimensionally displaying the first object. The first processor displays the first object on the first display based on the first image data in a first display manner, which is predetermined one display manner of two-dimensional display and three-dimensional display. When receiving a command for transmitting the transmission data with the object being displayed on the display, the first processor starts a process to transmit the transmission data to the second communication device using the first communication interface. When starting the process, the first processor displays the first object on the first display in a different display manner of the two-dimensional display and the three-dimensional display than the first display manner. The second processor receives the transmission data from the first communication device using the second communication interface. When starting to receive the transmission data, the second processor displays a second object on the second display in a second display manner, which is predetermined one display manner of the two-dimensional display and the three-dimensional display, based on second image data stored in the second memory and including right-eye image data and left-eye image data. After displaying the second object in the second display manner, the second processor displays the second object on the second display in a different display manner of the two-dimensional display and the three-dimensional display than the second display manner.

Preferably, during the three-dimensional display, the first processor changes a stereoscopic amount of the first object on the first display with passage of time. During the three-dimensional display, the second processor changes a stereoscopic amount of the second object on the second display with passage of time.

Preferably, the first processor further transmits the first image data to the second communication device. The second processor further receives the first image data transmitted by the first communication device. The second processor displays the same object as the first object on the second display as the second object by using the first image data as the second image data.

Preferably, the second memory has the second image data, which indicates an image of the second object, stored therein in advance prior to the communication with the first communication device. The second object is the same as the first object.

Preferably, when starting the process to transmit the transmission data to the second communication device, the first processor changes a stereoscopic amount of the first object while moving the first object in a predetermined first direction. When receiving the transmission data from the first communication device, the second processor changes a stereoscopic amount of the second object while moving the second object in the first direction or a predetermined second direction different from the first direction.

In accordance with yet another aspect of the present invention, a display control method is a display control method in a transmitter including a processor, a memory connected to the processor, a display, and a communication interface. Transmission data and image data for displaying an object are stored in the memory. The image data includes right-eye image data and left-eye image data for three-dimensionally displaying the object. The display control method includes the steps of: when receiving a command for transmitting the transmission data, the processor starting a process to transmit the transmission data to a receiver using the communication interface; when starting the process, the processor displaying the object on the display based on the image data in predetermined one display manner of two-dimensional display and three-dimensional display; and after displaying the object in the one display manner, the processor displaying the object on the display in a different display manner of the two-dimensional display and the three-dimensional display than the one display manner.

In accordance with still another aspect of the present invention, a display control method is a display control method in a transmitter including a processor, a memory connected to the processor, a display, and a communication interface. Transmission data and image data for displaying an object are stored in the memory. The image data includes right-eye image data and left-eye image data for three-dimensionally displaying the object. The display control method includes the steps of: the processor displaying the object on the display based on the image data in predetermined one display manner of two-dimensional display and three-dimensional display; when receiving a command for transmitting the transmission data with the object being displayed on the display, the processor starting a process to transmit the transmission data to a receiver using the communication interface; and when starting the process, the processor displaying the object on the display in a different display manner of the two-dimensional display and the three-dimensional display than the one display manner.

In accordance with yet another aspect of the present invention, a display control method is a display control method in a receiver including a processor, a memory connected to the processor, a display, and a communication interface. The display control method includes the steps of: the processor receiving transmission data, which is transmitted from a transmitter, using the communication interface; when starting to receive the transmission data, the processor reading out image data including right-eye image data and left-eye image data, from the memory; the processor displaying an object on the display in predetermined one display manner of two-dimensional display and three-dimensional display based on the image data thus read out; and after displaying the object in the one display manner, the processor displaying the object on the display in a different display manner of the two-dimensional display and the three-dimensional display than the one display manner.

In accordance with still another aspect of the present invention, a program is a program for controlling a transmitter including a processor, a memory connected to the processor, a display, and a communication interface. Transmission data and image data for displaying an object are stored in the memory. The image data includes right-eye image data and left-eye image data for three-dimensionally displaying the object. The program causes the processor to perform the steps of: when receiving a command for transmitting the transmission data, starting a process to transmit the transmission data to a receiver using the communication interface; when starting the process, displaying the object on the display based on the image data in predetermined one display manner of two-dimensional display and three-dimensional display; and after displaying the object in the one display manner, displaying the object on the display in a different display manner of the two-dimensional display and the three-dimensional display than the one display manner.

In accordance with yet another aspect of the present invention, a program is a program for controlling a transmitter including a processor, a memory connected to the processor, a display, and a communication interface. Transmission data and image data for displaying an object are stored in the memory. The image data includes right-eye image data and left-eye image data for three-dimensionally displaying the object. The program causes the processor to perform the steps of: displaying the object on the display based on the image data in predetermined one display manner of two-dimensional display and three-dimensional display; when receiving a command for transmitting the transmission data with the object being displayed on the display, starting a process to transmit the transmission data to a receiver using the communication interface; and when starting the process, displaying the object on the display in a different display manner of the two-dimensional display and the three-dimensional display than the one display manner.

In accordance with still another aspect of the present invention, a program is a program for controlling a receiver including a processor, a memory connected to the processor, a display, and a communication interface. The program causes the processor to perform the steps of: receiving transmission data, which is transmitted from a transmitter, using the communication interface; when starting to receive the transmission data, reading out image data including right-eye image data and left-eye image data, from the memory; displaying an object on the display in predetermined one display manner of two-dimensional display and three-dimensional display based on the image data thus read out; and after displaying the object in the one display manner, displaying the object on the display in a different display manner of the two-dimensional display and the three-dimensional display than the one display manner.

### Advantageous Effects of Invention

According to the invention described above, the switching between the two-dimensional display and the three-dimensional display can be associated with data communication.

### BRIEF DESCRIPTION OF DRAWINGS

FIG. 1 shows a configuration of a communication system.

FIG. 2 shows a hardware configuration of the communication device.

FIG. 3 shows a hardware configuration of another communication device.

FIG. 4 shows a first example of screen transition.

FIG. 5 shows a second example of screen transition.

FIG. 6 shows a third example of screen transition.

FIG. 7 shows a fourth example of screen transition.

FIG. 8 is a flowchart showing a flow of a process performed by the communication terminal.

FIG. 9 is a flowchart showing a flow of a process performed by the another communication terminal.

FIG. 10 is a flowchart showing another flow of the process performed by the communication terminal.

FIG. 11 is a flowchart showing another flow of the process performed by the another communication terminal.

FIG. 12 shows a first example of screen transition in the variation.

FIG. 13 shows a second example of screen transition in the variation.

FIG. 14 shows a third example of screen transition in the variation.

FIG. 15 shows a fourth example of screen transition in the variation.

FIG. 16 shows a variation of the communication system.

### DESCRIPTION OF EMBODIMENTS

The following describes embodiments of the present invention with reference to figures. In the description below, the same components are given the same reference characters. Their names and functions are also the same. Hence, they are not described repeatedly in detail.

<Outline of Communication System>

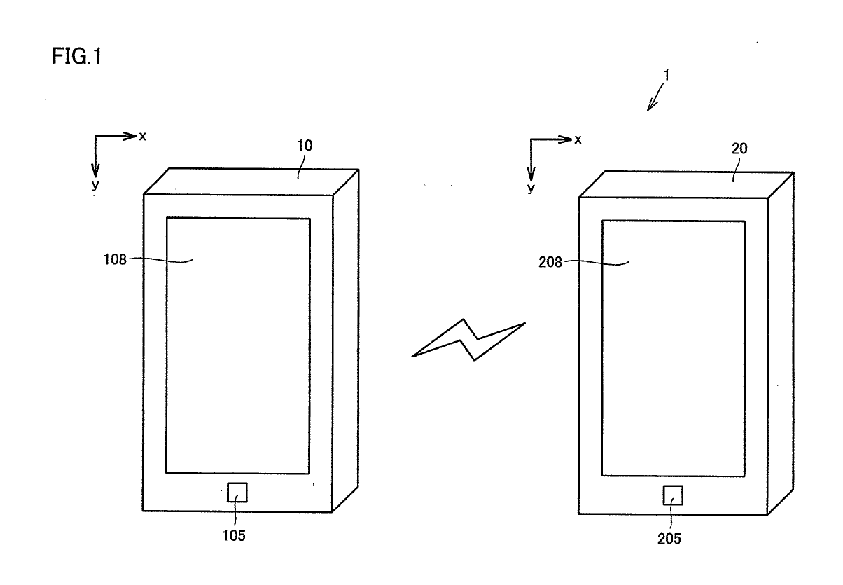

FIG. 1 shows a configuration of a communication system 1. Referring to FIG. 1, communication system 1 includes a communication device 10 (transmitter; first communication device) and a communication device 20 (receiver; second communication device). Each of communication device 10 and communication device 20 is, for example, a mobile telephone or a PDA (Personal Digital Assistant).

Communication device 10 includes an operation key 105 and a display 108. Communication device 20 includes an operation key 205 and a display 208. Communication device 10 and communication device 20 communicate with each other. It should be noted that a type of communication between communication device 10 and communication device 20 is not particularly limited. Examples of the type of communication include various types of communication such as: communication through WiFi (Wireless Fidelity); communication based on Bluetooth® standard; infrared communication; and the like.

Each of communication device 10 and communication device 20 is configured to be capable of two-dimensional display and three-dimensional display. Each of communication device 10 and communication device 20 employs a parallax barrier method as a method of the three-dimensional display. Each of communication device 10 and communication device 20 alternately displays a right-eye image and a left-eye image on each of displays 108, 208 in the x direction. It should be noted that the method of three-dimensional display is not limited to the parallax barrier method and may employ various types of method such as a lenticular method, a polarizing plate method, and a liquid crystal active shutter glasses method.

In the description below, it is assumed that communication device 10 is a terminal of transmitting side and communication device 20 is a terminal of receiving side. In other words, the description below exemplifies and illustrates a case where communication device 10 serves as a transmitter and communication device 20 serves as a receiver.

<Hardware Configurations of Communication Devices>

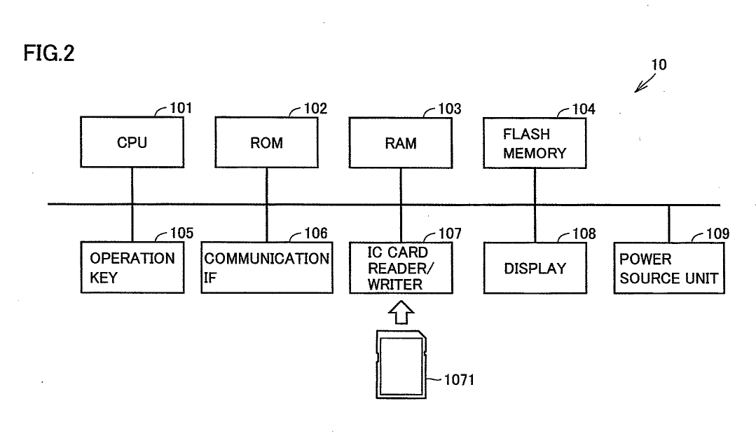

FIG. 2 shows a hardware configuration of communication device 10. Referring to FIG. 2, communication device 10 includes: a CPU (Central Processing Unit) 101 for executing a program; a ROM (Read Only Memory) 102 for storing data therein in a nonvolatile manner; a RAM (Random Access Memory) 103 for storing data therein in a volatile manner; a flash memory 104 of NAND type; operation key 105 for receiving a command from a user of communication device 10; a communication IF (Interface) 106; an IC (Integrated Circuit) card reader/writer 107; display 108; and a power source unit 109.

Flash memory 104 is a nonvolatile semiconductor memory. In flash memory 104, various types of data are stored in a nonvolatile manner, such as data generated by communication device 10 and data obtained from a device external to communication device 10.

Communication IF 106 performs signal processing so as to allow communication device 10 to wirelessly communicate with an external communication device (such as communication device 20). Power source unit 109 supplies electric power to CPU 101, communication IF 106, IC card reader/writer 107, display 108, and the like via a data bus.

These components 101 to 109 are connected to one another via the data bus. A memory card 1071 is placed into IC card reader/writer 107.

A process in communication device 10 is implemented by the hardware and software executed by CPU 101. Such software may be stored in flash memory 104 in advance. Alternatively, the software may be stored in memory card 1071 or other storage media and may be distributed as a program product. Alternatively, the software may be provided as a downloadable program product by a so-called information service provider connected to the Internet. Such software is read from the storage medium by IC card reader/writer 107 or other reading devices or is downloaded via the communication IF, and thereafter is stored temporarily in flash memory 104. The software is read from flash memory 104 by CPU 101, and is stored in flash memory 104 in the form of an executable program. CPU 101 executes the program.

Each of the components included in communication device 10 in the figure is a general component. Hence, it can be also said that an essential part of the present invention lies in the software stored in flash memory 104, memory card 1071, or other storage media, or the software downloadable via a network. It should be noted that operations of the hardware of communication device 10 are well known and are not described repeatedly in detail.

It should be noted that the storage media are not limited to a DVD-ROM, a CD-ROM, a FD (Flexible Disk), and a hard disk, and may be any media holding a program in a fixed manner such as a magnetic tape, a cassette tape, an optical disk (MO (Magnetic Optical Disc)/MD (Mini Disc)/DVD (Digital Versatile Disc)), an optical card, and semiconductor memories such as a mask ROM, an EPROM (Electronically Programmable Read-Only Memory), an EEPROM (Electronically Erasable Programmable Read-Only Memory), and a flash ROM. Further, each of the storage media is a non-transitory medium from which a computer can read the program or the like.

Here, the term “program” is intended to include not only a program directly executable by the CPU but also a program in the form of source program, a compressed program, an encrypted program, and the like.

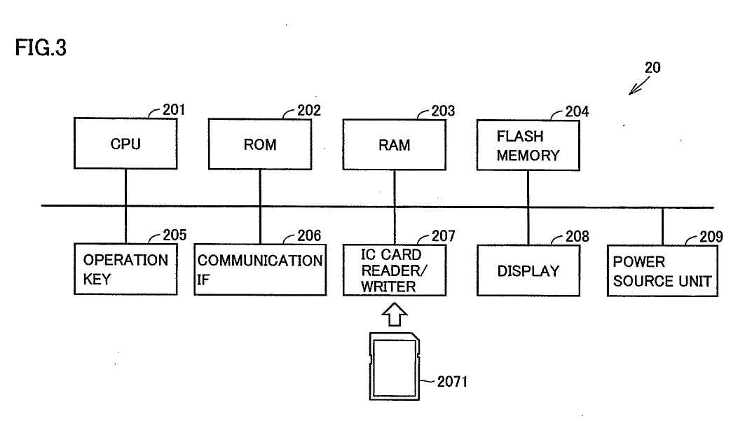

FIG. 3 shows a hardware configuration of communication device 20. Referring to FIG. 3, communication device 20 includes: a CPU 201 for executing a program; a ROM 202 for storing data therein in a nonvolatile manner; a RAM 203 for storing data therein in a volatile manner; a flash memory 204 of NAND type; operation key 205 for receiving a command from a user of communication device 20; a communication IF 206; an IC card reader/writer 207; display 208; and a power source unit 209. The hardware configuration of communication device 20 is similar to the hardware configuration of communication device 10, and is therefore not described repeatedly here.

<Examples of Screen Transition>

The following describes four examples of screen transition in each of communication device 10 and communication device 20 when communication device 10 transmits data desired by a user (hereinafter, referred to as “data D1”) to communication device 20.

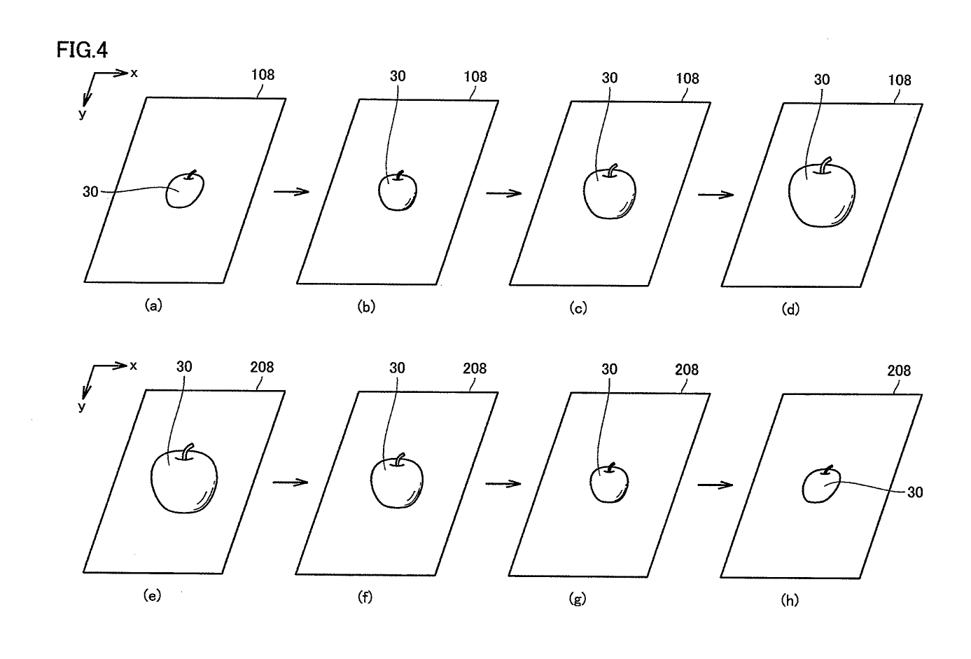

In communication device 10, flash memory 104 has data D1 and image data (hereinafter, referred to as “image data D2”) stored therein. Image data D2 is to display an object 30 (see FIG. 4). Communication device 10 transmits data D1 and image data D2 associated with data D1 to communication device 20. Communication device 20 receives data D1 and image data D2, and temporarily stores them in RAM 203. When communication device 20 receives a command to store the received data, communication device 20 stores data D1 and image data D2, which are stored in RAM 203, in flash memory 204.

Image data D2 includes right-eye image data D21 and left-eye image data D22 for three-dimensionally displaying object 30. It should be noted that data D1 and image data D2 may be stored in flash memory 104 as separate files or may be stored in such a form that image data D2 is included in data D1.

Data D1 may be data of any type. For example, data D1 is text data or image data. When data D1 is image data of a photo, image data D2 is image data of a thumbnail image (object) of the photo, for example. The object is not particularly limited, but is preferably associated with data D1.

The following exemplifies and illustrates a case where data D1 represents a photographic image (detailed image) of an apple and image data D2 represents thumbnail image data of the apple. Further, in the description below, it is assumed that communication device 10 transmits image data D2 to communication device 20 prior to transmission of data D1. In addition, it is assumed that a data amount of data D1 is described in the header of data D1.

FIG. 4 shows a first example of screen transition. Referring to FIG. 4(a), when receiving, via operation key 105, a command for transmitting data D1, CPU 101 of communication device 10 starts a process to transmit data D1 to communication device 20 using communication IF 106. When starting the process to transmit data D1, CPU 101 two-dimensionally displays object 30 of the apple on display 108 based on image data D2.

It should be noted that CPU 101 may use right-eye image data D21 or left-eye image data D22 of image data D2 for the two-dimensional display of object 30, for example. The method for two-dimensionally displaying object 30 is not particularly limited. For example, right-eye image data D21 and left-eye image data D22 may be combined such that there is substantially no parallax between the right-eye image and the left-eye image. Alternatively, two-dimensional image data may be included in image data D2 apart from right-eye image data D21 and left-eye image data D22, and CPU 101 may use the two-dimensional image data to implement the two-dimensional display of object 30.

Referring to FIG. 4(b), when CPU 101 determines that a first ratio (for example 25%) of data D1 has been transmitted after two-dimensionally displaying object 30, CPU 101 three-dimensionally displays object 30 on display 108 with a stereoscopic amount being a value V1. Referring to FIG. 4(c), when CPU 101 determines that a second ratio (for example 50%) of data D1 has been transmitted after three-dimensionally displaying object 30 on display 108 with the stereoscopic amount being value V1, CPU 101 three-dimensionally displays object 30 on display 108 with the stereoscopic amount being a value V2 (V2>V1).

Referring to FIG. 4(d), when CPU 101 determines that a third ratio (for example 75%) of data D1 has been transmitted after three-dimensionally displaying object 30 on display 108 with the stereoscopic amount being value V2, CPU 101 three-dimensionally displays object 30 on display 108 with the stereoscopic amount being a value V3 (V3>V2). Meanwhile, when the transmission of data D1 is completed, CPU 101 stops displaying object 30.

As described above, CPU 101 changes the display manner of object 30 from the two-dimensional display to the three-dimensional display with passage of time after starting the transmission of data D1. Further, during the three-dimensional display, CPU 101 gradually increases the stereoscopic amount of object 30 with passage of time.

It should be noted that in FIG. 4 and FIG. 5 to FIG. 8 described below, object 30 is illustrated to become larger as the stereoscopic amount becomes larger, in order to express differences in stereoscopic amount of object 30. However, actually, CPU 101 does not enlarge object 30 in accordance with the stereoscopic amount. However, each of communication devices 10, 20 may be configured to increase the size of object 30 in accordance with the stereoscopic amount.

Referring to FIG. 4(e), when starting to receive data D1 using communication IF 206, CPU 201 of communication device 20 three-dimensionally displays object 30 on display 208 with a stereoscopic amount being value V3. Referring to FIG. 4(f), when CPU 201 determines that a first ratio (for example 25%) of data D1 has been received after three-dimensionally displaying object 30 on display 208 with the stereoscopic amount being value V3, CPU 201 three-dimensionally displays object 30 on display 208 with the stereoscopic amount being value V2.

Referring to FIG. 4(g), when CPU 201 determines that a second ratio (for example 50%) of data D1 has been received after three-dimensionally displaying object 30 on display 208 with the stereoscopic amount being value V2, CPU 201 three-dimensionally displays object 30 on display 208 with the stereoscopic amount being value V1. Referring to FIG. 4(h), when CPU 201 determines that a third ratio (for example 75%) of data D1 has been received after three-dimensionally displaying object 30 on display 208 with the stereoscopic amount being value V1, CPU 201 two-dimensionally displays object 30 on display 208.

Further, when the reception of data D1 is completed, CPU 201 displays an indication on display 208 to notify that the reception has been completed. It should be noted that when the reception is completed, CPU 201 may stop displaying object 30 or may keep on displaying object 30.

As described above, CPU 201 changes the display manner of object 30 from the three-dimensional display to the two-dimensional display with passage of time during reception of data D1. Further, during the three-dimensional display, CPU 201 gradually decreases the stereoscopic amount of object 30 with passage of time.

By communication device 10 and communication device 20 performing the above-described processes, the switching between the two-dimensional display and the three-dimensional display can be associated with data communication. Further, the user intuitively understands that data communication is currently being in progress. As described above, when there is association between object 30 and data D1 as in the case where object 30 is a thumbnail image of data D1, the user immediately understands what kind of data data D1 is.

For ease of description, it is assumed that the first ratio is 25%, the second ratio is 50%, and the third ratio is 75% in the description below.

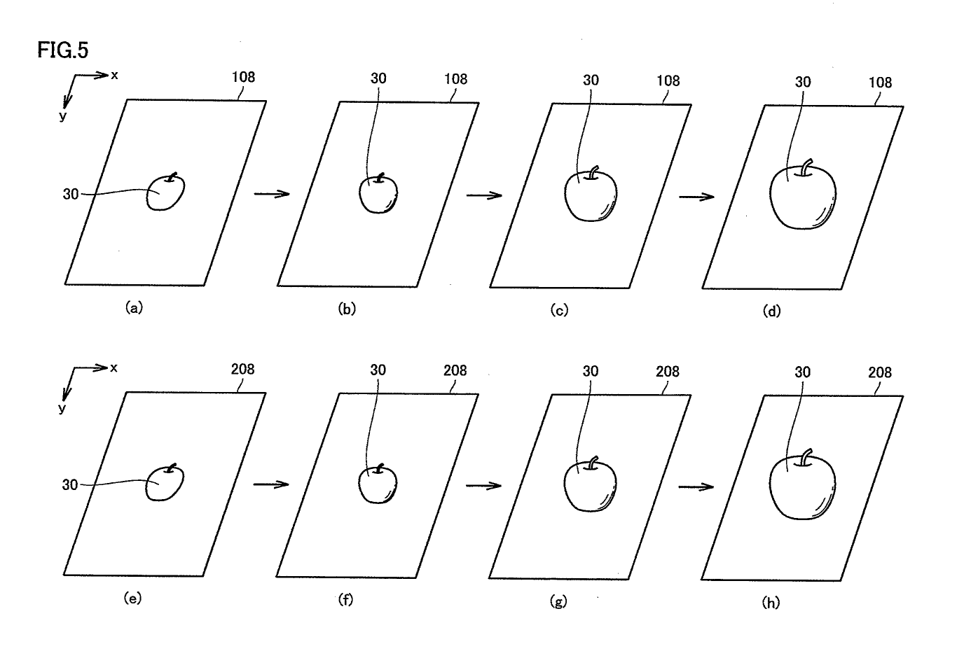

FIG. 5 shows a second example of screen transition. It should be noted that FIGS. 5(a), (b), (c), and (d) are respectively the same as FIGS. 4(a), (b), (c), and (d). Hence, explanation for FIGS. 5(a) to (d) is not made repeatedly.

Referring to FIG. 5(e), when starting to receive data D1 using communication IF 206, CPU 201 of communication device 20 two-dimensionally displays object 30 on display 208 based on image data D2. Referring to FIG. 5(f), when CPU 201 determines that 25% of data D1 has been received after two-dimensionally displaying object 30, CPU 201 three-dimensionally displays object 30 on display 208 with the stereoscopic amount being value V1.

Referring to FIG. 5(g), when CPU 201 determines that 50% of data D1 has been received after three-dimensionally displaying object 30 on display 208 with the stereoscopic amount being value V1, CPU 201 three-dimensionally displays object 30 on display 208 with the stereoscopic amount being value V2. Referring to FIG. 5(h), when CPU 201 determines that 75% of data D1 has been received after three-dimensionally displaying object 30 on display 208 with the stereoscopic amount being value V2, CPU 201 three-dimensionally displays object 30 on display 208 with the stereoscopic amount being value V3. Further, when the reception of data D1 is completed, CPU 201 displays an indication on display 208 to notify that the reception has been completed.

As described above, CPU 201 changes the display manner of object 30 from the two-dimensional display to the three-dimensional display with passage of time during reception of data D1. Further, during the three-dimensional display, CPU 201 gradually increases the stereoscopic amount of object 30 with passage of time.

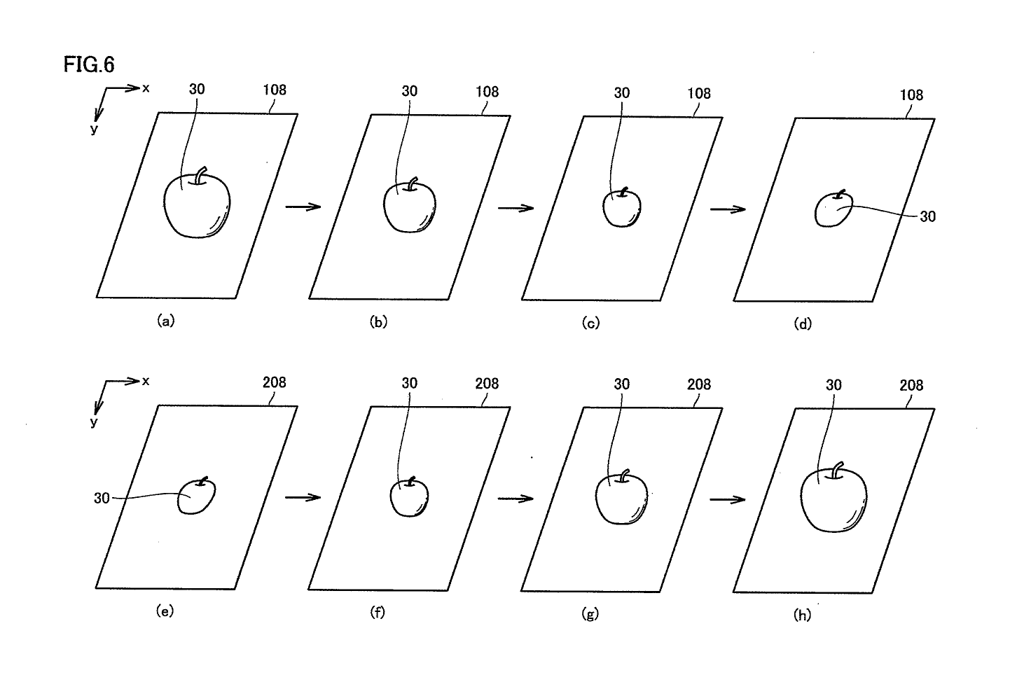

FIG. 6 shows a third example of screen transition. It should be noted that FIGS. 6(e), (f), (g), and (h) are respectively the same as FIGS. 5(e), (f), (g), and (h). Hence, explanation for FIGS. 6(e) to (h) is not made repeatedly.

Referring to FIG. 6(a), when starting a process to transmit data D1, CPU 101 of communication device 10 three-dimensionally displays object 30 on display 108 with the stereoscopic amount being value V3. Referring to FIG. 6(b), when CPU 101 determines that 25% of data D1 has been transmitted after three-dimensionally displaying object 30 on display 108 with the stereoscopic amount being value V3, CPU 101 three-dimensionally displays object 30 on display 108 with the stereoscopic amount being value V2.

Referring to FIG. 6(c), when CPU 101 determines that 50% of data D1 has been transmitted after three-dimensionally displaying object 30 on display 108 with the stereoscopic amount being value V2, CPU 101 three-dimensionally displays object 30 on display 108 with the stereoscopic amount being value V1. Referring to FIG. 6(d), when CPU 101 determines that 75% of data D1 has been transmitted after three-dimensionally displaying object 30 on display 108 with the stereoscopic amount being value V1, CPU 101 two-dimensionally displays object 30 on display 108. Further, when the transmission of data D1 is completed, CPU 101 stops displaying object 30.

As described above, CPU 101 changes the display manner of object 30 from the three-dimensional display to the two-dimensional display with passage of time after starting the transmission of data D1. Further, during the three-dimensional display, CPU 101 gradually decreases the stereoscopic amount of object 30 with passage of time.

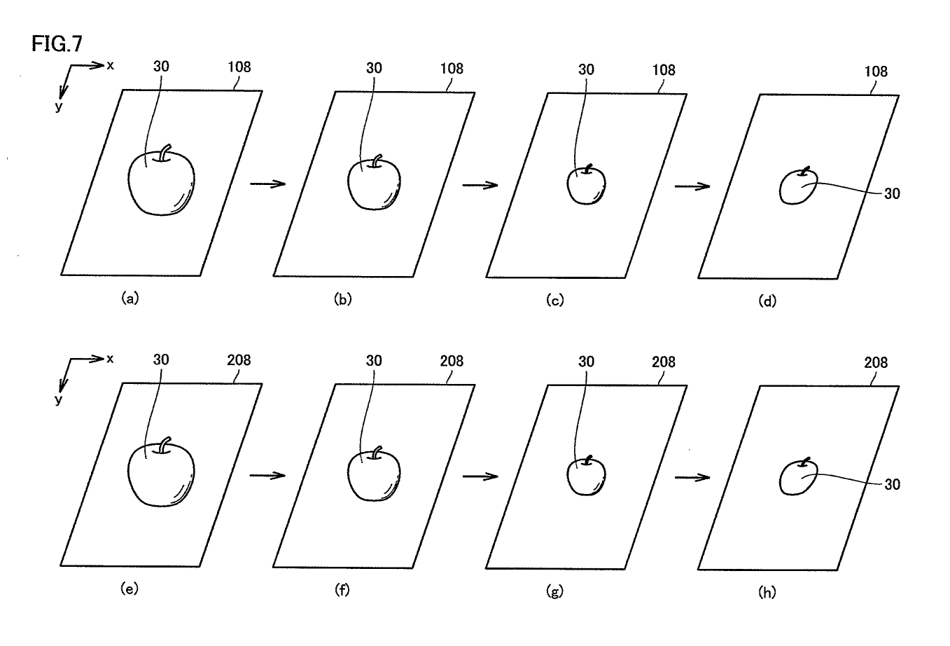

FIG. 7 shows a fourth example of screen transition. FIGS. 7(a), (b), (c), and (d) are respectively the same as FIGS. 6(a), (b), (c), and (d). FIGS. 7(e), (f), (g), and (h) are respectively the same as FIGS. 4(e), (f), (g), and (h).

In other words, CPU 101 changes the display manner of object 30 from the three-dimensional display to the two-dimensional display with passage of time after starting the transmission of data D1. Further, during the three-dimensional display, CPU 101 gradually decreases the stereoscopic amount of object 30 with passage of time.

Meanwhile, CPU 201 changes the display manner of object 30 from the three-dimensional display to the two-dimensional display with passage of time during reception of data D1. Further, during the three-dimensional display, CPU 201 gradually decreases the stereoscopic amount of object 30 with passage of time.

It should be noted that control over the stereoscopic amount can be implemented by changing a positional displacement between the right-eye image and the left-eye image in each of displays 108, 208. By increasing the displacement, the stereoscopic amount can be larger. By decreasing the displacement, the stereoscopic amount can be smaller. In other words, when the parallax is made larger, the stereoscopic amount becomes larger. When the parallax is made smaller, the stereoscopic amount becomes smaller.

The description above has exemplified and illustrated the configuration in which communication device 10 displays object 30 on display 108 after starting to transmit data D1, but the present invention is not limited to this. Communication device 10 may be configured to display object 30 on display 108 in advance and thereafter three-dimensionally display object 30 when receiving a command to transmit data D1. In other words, communication device 10 may be configured to change the two-dimensional display of object 30 to three-dimensional display when CPU 101 starts to transmit data D1. Also in this case, CPU 101 changes the stereoscopic amount of object 30 with passage of time.

<Control Structure>

The following describes flows of processes performed by communication device 10 and communication device 20, assuming that the screen transition in each of communication device 10 and communication device 20 is made in the manner of the screen transition shown in FIG. 4.

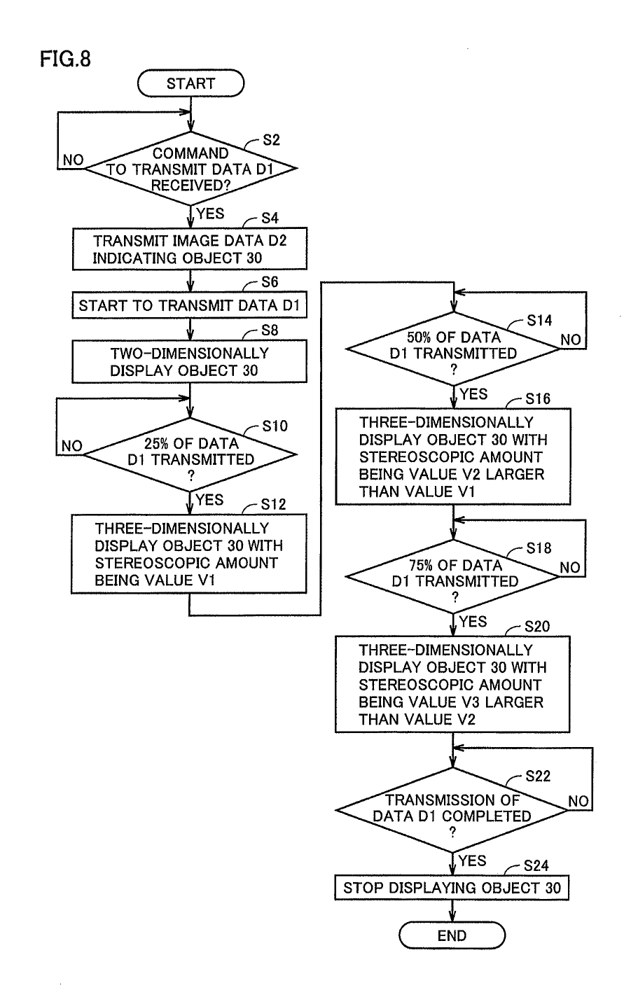

FIG. 8 is a flowchart showing a flow of a process performed by communication device 10. Referring to FIG. 8, in a step S2, CPU 101 determines whether or not a command to transmit data D1 has been received. When CPU 101 determines that the command has been received (YES in step S2), CPU 101 transmits image data D2, which indicates object 30, to communication device 20 in a step S4. When CPU 101 determines that no command has been received (NO in step S2), CPU 101 brings the process back to step S2.

In a step S6, CPU 101 starts to transmit data D1. In a step S8, CPU 101 two-dimensionally displays object 30 on display 108.

In a step S10, CPU 101 determines whether or not 25% of data D1 has been transmitted. When CPU 101 determines that 25% of data D1 has been transmitted (YES in step S10), CPU 101 three-dimensionally displays object 30 in a step S12 with the stereoscopic amount being value V1. When CPU 101 determines that 25% of data D1 has not been transmitted (NO in step S10), CPU 101 brings the process back to step S10.

In a step S14, CPU 101 determines whether or not 50% of data D1 has been transmitted. When CPU 101 determines that 50% of data D1 has been transmitted (YES in step S14), CPU 101 three-dimensionally displays object 30 in a step S16 with the stereoscopic amount being value V2 (V2>V1). When CPU 101 determines that 50% of data D1 has not been transmitted (NO in step S14), CPU 101 brings the process back to step S14.

In a step S18, CPU 101 determines whether or not 75% of data D1 has been transmitted. When CPU 101 determines that 75% of data D1 has been transmitted (YES in step S18), CPU 101 three-dimensionally displays object 30 in a step S20 with the stereoscopic amount being value V3 (V3>V2). When CPU 101 determines that 75% of data D1 has not been transmitted (NO in step S18), CPU 101 brings the process back to step S18.

In a step S22, CPU 101 determines whether or not the transmission of data D1 has been completed. When CPU 101 determines that the transmission has been completed (YES in step S22), CPU 101 stops displaying object 30 in a step S24. When CPU 101 determines that the transmission has not been completed (NO in step S22), CPU 101 brings the process back to step S22.

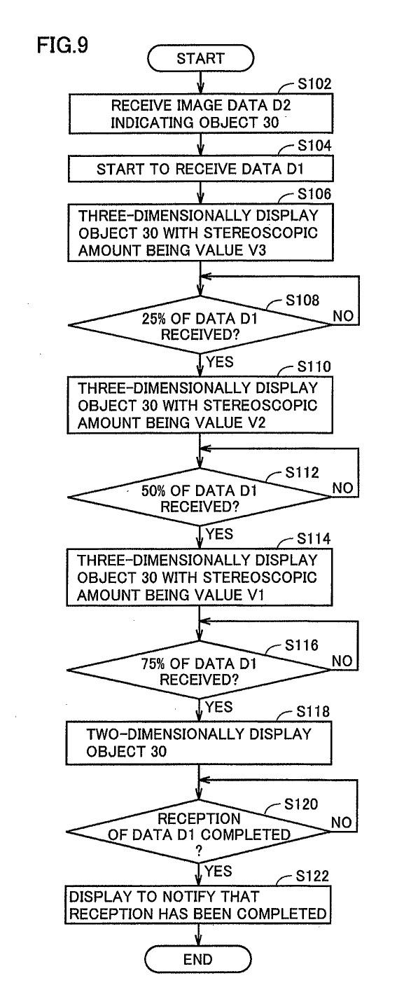

FIG. 9 is a flowchart showing a flow of a process performed by communication device 20. Referring to FIG. 9, in a step S 102, CPU 201 receives image data D2 from communication device 10. In a step S104, CPU 201 starts to receive data D1. In a step S106, CPU 201 three-dimensionally displays object 30 with the stereoscopic amount being value V3.

In a step S108, CPU 201 determines whether or not 25% of data D1 has been received. When CPU 201 determines that 25% of data D1 has been received (YES in step S108), CPU 201 three-dimensionally displays object 30 in a step S110 with the stereoscopic amount being value V2. When CPU 201 determines that 25% of data D1 has not been received (NO in step S108), CPU 201 brings the process back to step S108.

In a step S112, CPU 201 determines whether or not 50% of data D1 has been received. When CPU 201 determines that 50% of data D1 has been received (YES in step S112), CPU 201 three-dimensionally displays object 30 in a step S114 with the stereoscopic amount being value V1. When CPU 201 determines that 50% of data D1 has not been received (NO in step S112), CPU 201 brings the process back to step S112.

In a step S116, CPU 201 determines whether or not 75% of data D1 has been received. When CPU 201 determines that 75% of data D1 has been received (YES in step S116), CPU 201 two-dimensionally displays object 30 in a step S118. When CPU 201 determines that 75% of data D1 has not been received (NO in step S116), CPU 201 brings the process back to step S116.

In a step S120, CPU 201 determines whether or not the reception of data D1 has been completed. When CPU 201 determines that the reception of data D1 has been completed (YES in step S120), CPU 201 displays an indication on display 208 in step S122 to notify that the reception has been completed. When CPU 201 determines that the reception of data D1 has not been completed (NO in step S120), CPU 201 brings the process back to step S120.

<Variations>

(Variation of Control Structure)

FIG. 8 illustrates the example in which the display manner of object 30 is changed based on the ratio of transmission of data D1. FIG. 9 illustrates the example in which the display manner of object 30 is changed based on the ratio of reception of data D1. However, the method of changing the display manner of object 30 in accordance with the communication of data D1 is not limited to these.

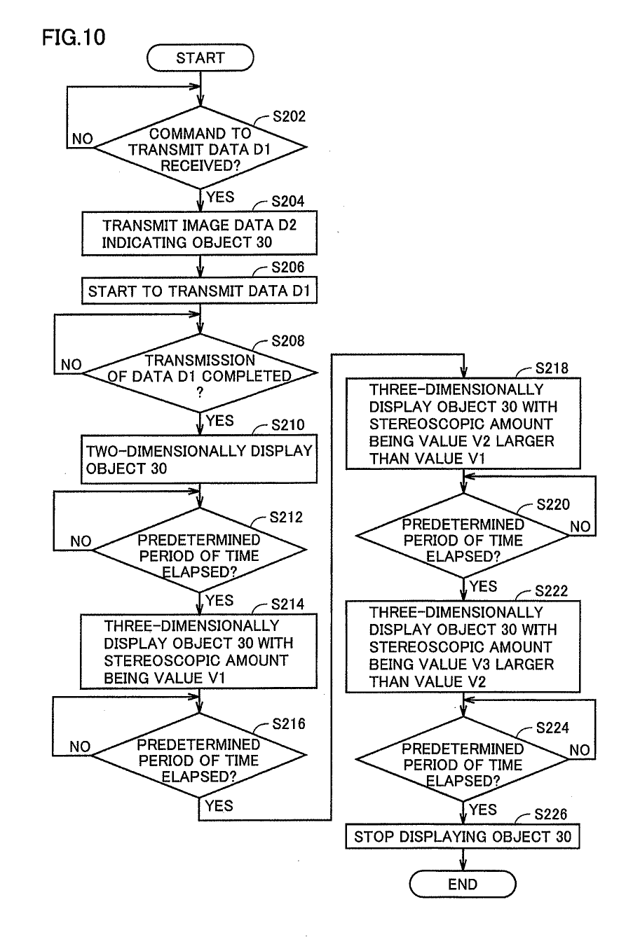

FIG. 10 is a flowchart showing another flow of the process performed by communication device 10. In a step S202, CPU 101 determines whether or not a command to transmit data D1 has been received. In a step S204, CPU 101 transmits image data D2. In a step S206, CPU 101 transmits data D1 to communication device 20 using communication IF 106.

In a step S208, CPU 101 determines whether or not the transmission of data D1 has been completed. When CPU 101 determines that the transmission has been completed (YES in step S208), CPU 101 two-dimensionally displays object 30 on display 108 in a step S210. When CPU 101 determines that the transmission has not been completed (NO in step S208), CPU 101 brings the process back to step S208.

In a step S212, CPU 101 determines whether or not a predetermined period of time has elapsed since the start of the two-dimensional display of object 30. It should be noted that CPU 101 measures the time using a timer (not shown) provided in communication device 10. When CPU 101 determines that the predetermined period of time has been elapsed (YES in step S212), CPU 101 three-dimensionally displays object 30 on display 108 in a step S214 with the stereoscopic amount being value V1. When CPU 101 determines that the predetermined period of time has not been elapsed (NO in step S212), CPU 101 brings the process back to step S212.

In a step S216, CPU 101 determines whether or not a predetermined period of time has been elapsed since the start of the three-dimensional display of object 30 with the stereoscopic amount being value V1. When CPU 101 determines that the predetermined period of time has been elapsed (YES in step S216), CPU 101 three-dimensionally displays object 30 on display 108 in a step S218 with the stereoscopic amount being value V2. When CPU 101 determines that the predetermined period of time has not been elapsed (NO in step S216), CPU 101 brings the process back to step S216.

In a step S220, CPU 101 determines whether or not a predetermined period of time has been elapsed since the start of the three-dimensional display of object 30 with the stereoscopic amount being value V2. When CPU 101 determines that the predetermined period of time has been elapsed (YES in step S220), CPU 101 three-dimensionally displays object 30 on display 108 in a step S222 with the stereoscopic amount being value V3. When CPU 101 determines that the predetermined period of time has not been elapsed (NO in step S220), CPU 101 brings the process back to step S220.

In a step S224, CPU 101 determines whether or not a predetermined period of time has been elapsed since the start of the three-dimensional display of object 30 with the stereoscopic amount being value V3. When CPU 101 determines that the predetermined period of time has been elapsed (YES in step S224), CPU 101 two-dimensionally displays object 30 on display 108 in a step S226. When CPU 101 determines that the predetermined period of time has not been elapsed (NO in step S224), CPU 101 brings the process back to step S224.

It should be noted that the predetermined periods of time in step S212, step S216, step S220, and step S224 may be the same or at least one of them may be different from the other periods of time.

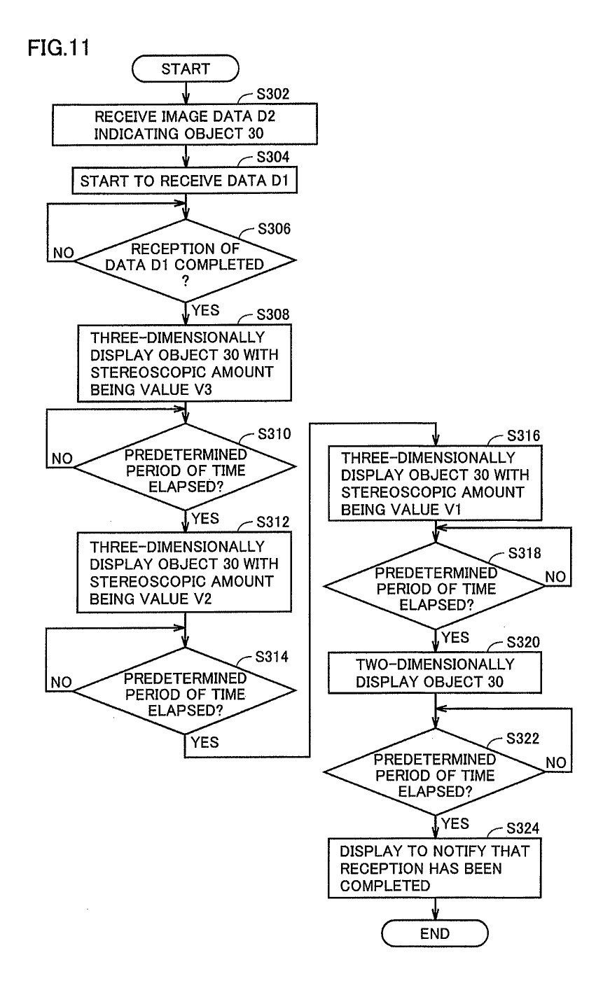

FIG. 11 is a flowchart showing another flow of the process performed by communication device 20. Referring to FIG. 11, in a step S302, CPU 201 receives image data D2 of object 30 from communication device 10. In a step S304, CPU 201 starts to receive data D1.

In a step S306, CPU 201 determines whether or not the reception of data D1 has been completed. When CPU 201 determines that the reception has been completed (YES in step S306), CPU 201 three-dimensionally displays object 30 on display 208 in a step S308 with the stereoscopic amount being value V3. When CPU 201 determines that the reception has not been completed (NO in step S306), CPU 201 brings the process back to step S306.

In a step S310, CPU 201 determines whether or not a predetermined period of time has been elapsed since the start of the three-dimensional display of object 30 with the stereoscopic amount being value V3. It should be noted that CPU 201 measures the time using a timer (not shown) provided in communication device 20. When CPU 201 determines that the predetermined period of time has been elapsed (YES in step S310), CPU 201 three-dimensionally displays object 30 on display 208 in a step S312 with the stereoscopic amount being value V2. When CPU 201 determines that the predetermined period of time has not been elapsed (NO in step S310), CPU 201 brings the process back to step S310.

In a step S314, CPU 201 determines whether or not a predetermined period of time has been elapsed since the start of the three-dimensional display of object 30 with the stereoscopic amount being value V2. When CPU 201 determines that the predetermined period of time has been elapsed (YES in step S314), CPU 201 three-dimensionally displays object 30 on display 208 in a step S316 with the stereoscopic amount being value V1. When CPU 201 determines that the predetermined period of time has not been elapsed (NO in step S314), CPU 201 brings the process back to step S314.

In a step S318, CPU 201 determines whether or not a predetermined period of time has been elapsed since the start of the three-dimensional display of object 30 with the stereoscopic amount being value V1. When CPU 201 determines that the predetermined period of time has been elapsed (YES in step S318), CPU 201 two-dimensionally displays object 30 on display 208 in a step S320. When CPU 201 determines that the predetermined period of time has not been elapsed (NO in step S318), CPU 201 brings the process back to step S318.

In a step S322, CPU 201 determines whether or not a predetermined period of time has elapsed since the start of the two-dimensional display of object 30. When CPU 201 determines that the predetermined period of time has been elapsed (YES in step S322), CPU 201 displays an indication on display 208 in a step S324 to notify that the reception has been completed. When CPU 201 determines that the predetermined period of time has not been elapsed (NO in step S322), CPU 201 brings the process back to step S322.

It should be noted that the predetermined periods of time in step S310, step S314, step S318, and step S322 may be the same or at least one of them may be different from the other periods of time.

(Variation of Screen Transition)

In each of FIG. 4 to FIG. 7, the coordinates of the object in each of displays 108, 208 are unchanged between the case where object 30 is displayed as the two-dimensional image and the case where object 30 is displayed as the three-dimensional image.

The following describes a configuration in which the stereoscopic amount of object 30 is changed while moving object 30 in a predetermined direction, when CPU 101 starts a process to transmit data D1 to communication device 20. Also, the following describes a configuration in which the stereoscopic amount of object 30 is changed while moving object 30 in the foregoing direction or a predetermined direction different from the foregoing direction, when CPU 201 receives data D1 from communication device 10.

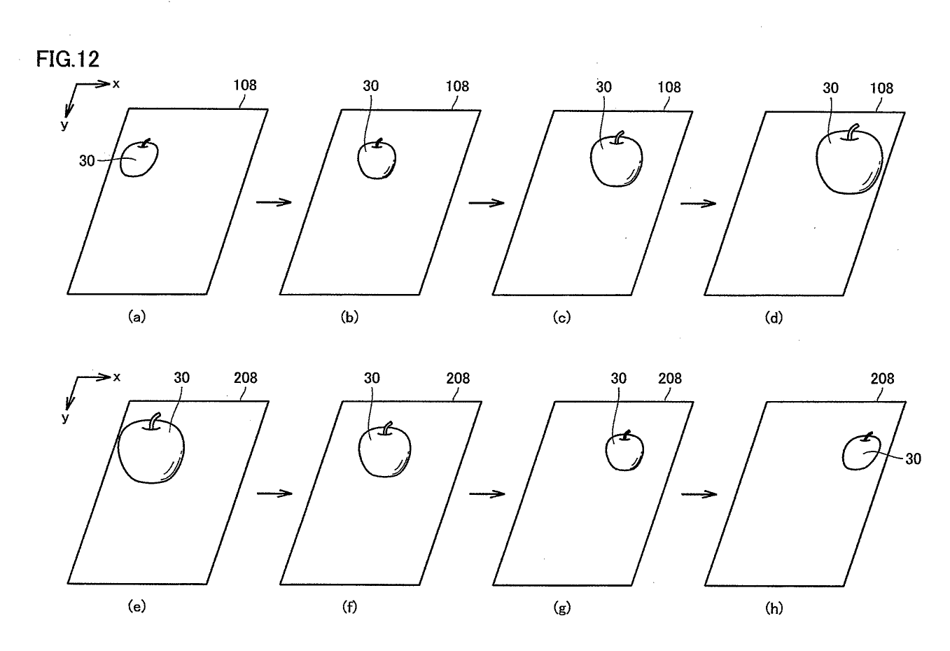

In a manner similar to those in FIG. 4 to FIG. 7, there are provided four examples of screen transition in communication device 10 and communication device 20 when communication device 10 transmits data D1 to communication device 20. It should be noted that FIGS. 12, 13, 14, and 15 respectively correspond to FIGS. 4, 5, 6, and 7. In the description below, it is illustrated that object 30 is moved in the positive direction on the x axis in each of communication device 10 and communication device 20.

FIG. 12 shows a first example of screen transition in the variation. Referring to FIG. 12(a), when starting a process to transmit data D1, CPU 101 two-dimensionally displays object 30 on display 108 at a predetermined position P0 (x0, y0) based on image data D2. Referring to FIG. 12(b), when CPU 101 determines that 25% of data D1 has been transmitted after two-dimensionally displaying object 30, CPU 101 three-dimensionally displays object 30 on display 108 at a position P1 (x1, y0) with the stereoscopic amount being value V1. It should be noted that x1>x0 is satisfied.

Referring to FIG. 12(c), when CPU 101 determines that 50% of data D1 has been transmitted after three-dimensionally displaying object 30 at position P1 (x1, y0) with the stereoscopic amount being value V1, CPU 101 three-dimensionally displays object 30 on display 108 at a position P2 (x2, y0) with the stereoscopic amount being value V2. It should be noted that x2>x1 is satisfied. Referring to FIG. 12(d), when CPU 101 determines that 75% of data D1 has been transmitted after three-dimensionally displaying object 30 at position P2 (x2, y0) with the stereoscopic amount being value V2, CPU 101 three-dimensionally displays object 30 on display 108 at a position P3 (x3, y0) with the stereoscopic amount being value V3. It should be noted that x3>x2 is satisfied.

As described above, CPU 101 changes the display manner of object 30 from the two-dimensional display to the three-dimensional display with passage of time after starting the transmission of data D1. Further, during the three-dimensional display, CPU 101 gradually increases the stereoscopic amount of object 30 with passage of time. Further, CPU 101 changes the display manner of the object while moving the display position of object 30 on display 108 in one direction.

Referring to FIG. 12(e), when starting to receive data D1 using communication IF 206, CPU 201 of communication device 20 three-dimensionally displays object 30 on display 208 at a position P0′ (x0′, y0′) with the stereoscopic amount being value V3. Referring to FIG. 12(f), when CPU 201 determines that 25% of data D1 has been received after three-dimensionally displaying object 30 on display 208 at position P0′ (x0′, y0′) with the stereoscopic amount being value V3, CPU 201 three-dimensionally displays object 30 on display 208 at a position P1′ (x1′, y0′) with the stereoscopic amount being value V2. It should be noted that x1′>x0′ is satisfied.

Referring to FIG. 12(g), when CPU 201 determines that 50% of data D1 has been received after three-dimensionally displaying object 30 on display 208 at position P1′ (x1′, y0′) with the stereoscopic amount being value V2, CPU 201 three-dimensionally displays object 30 on display 208 at a position P2′ (x2′, y0′) with the stereoscopic amount being value V1. It should be noted that x2′>x1′ is satisfied. Referring to FIG. 12(h), when CPU 201 determines that 75% of data D1 has been received after three-dimensionally displaying object 30 on display 208 at position P2′ (x2′, y0′) with the stereoscopic amount being value V1, CPU 201 two-dimensionally displays object 30 on display 208 at a position P3′ (x3′, y0′). It should be noted that x3′>x2′ is satisfied.

As described above, CPU 201 changes the display manner of object 30 from the three-dimensional display to the two-dimensional display with passage of time during reception of data D1. Further, during the three-dimensional display, CPU 101 gradually decreases the stereoscopic amount of object 30 with passage of time. Further, CPU 201 changes the display manner of the object while moving the display position of object 30 on display 208 in one direction.

By communication device 10 and communication device 20 performing the above-described processes, the switching between the two-dimensional display and the three-dimensional display can be associated with data communication. Further, the user more intuitively understands that data communication is currently being in progress.

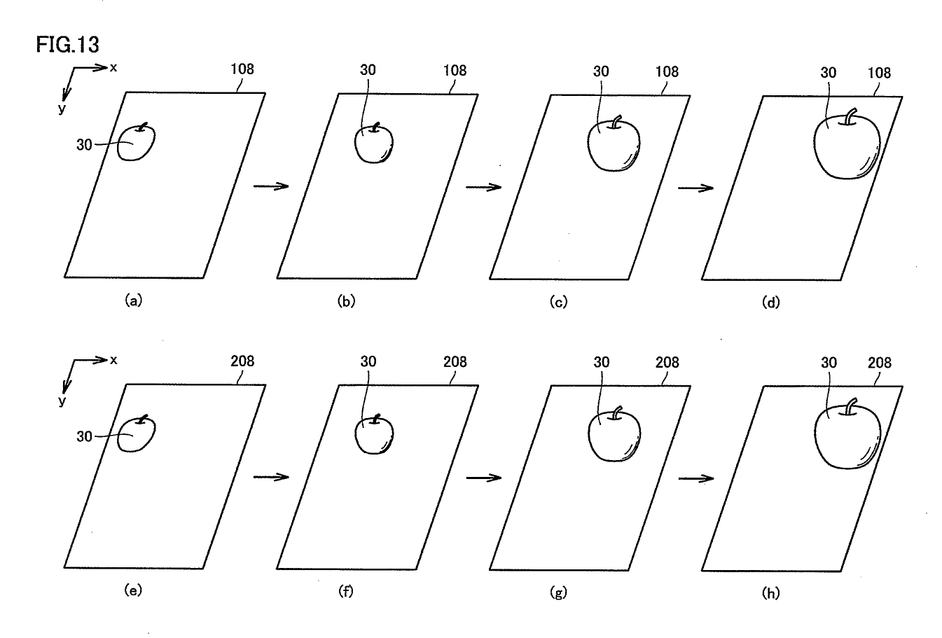

FIG. 13 shows a second example of screen transition in the variation. It should be noted that FIGS. 13(a), (b), (c), and (d) are respectively the same as FIGS. 12(a), (b), (c), and (d). Hence, explanation for FIGS. 13(a) to (d) is not made repeatedly.

Referring to FIG. 13(e), when starting to receive data D1 using communication IF 206, CPU 201 of communication device 20 two-dimensionally displays object 30 on display 208 at position P0′ (x0′, y0′) based on image data D2. Referring to FIG. 13(f), when CPU 201 determines that 25% of data D1 has been received after two-dimensionally displaying object 30 at position P0′ (x0′, y0′), CPU 201 three-dimensionally displays object 30 on display 208 at position P1′ (x1′, y0′) with the stereoscopic amount being value V1.

Referring to FIG. 13(g), when CPU 201 determines that 50% of data D1 has been received after three-dimensionally displaying object 30 on display 208 at position P1′ (x1′, y0′) with the stereoscopic amount being value V1, CPU 201 three-dimensionally displays object 30 on display 208 at position P2′ (x2′, y0′) with the stereoscopic amount being value V2. Referring to FIG. 13(h), when CPU 201 determines that 75% of data D1 has been received after three-dimensionally displaying object 30 on display 208 at position P2′ (x2′, y0′) with the stereoscopic amount being value V2, CPU 201 three-dimensionally displays object 30 on display 208 at position P3′ (x3′, y0′) with the stereoscopic amount being value V3. Further, when the reception of data D1 is completed, CPU 201 displays an indication on display 208 to notify that the reception has been completed.

As described above, CPU 201 changes the display manner of object 30 from the two-dimensional display to the three-dimensional display with passage of time during reception of data D1. Further, during the three-dimensional display, CPU 201 gradually increases the stereoscopic amount of object 30 with passage of time. Further, CPU 201 changes the display manner of the object while moving the display position of object 30 on display 208 in one direction.

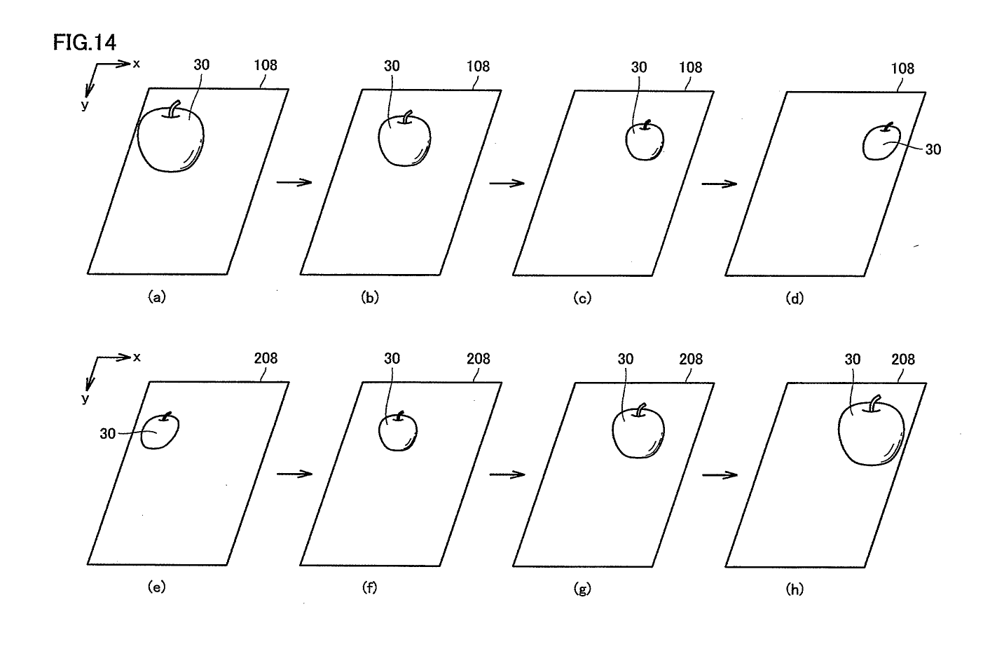

FIG. 14 shows a third example of screen transition in the variation. It should be noted that FIGS. 14(e), (f), (g), and (h) are respectively the same as FIGS. 13(e), (f), (g), and (h). Hence, explanation for FIGS. 14(e) to (h) is not made repeatedly.

Referring to FIG. 14(a), when starting a process to transmit data D1, CPU 101 of communication device 10 three-dimensionally displays object 30 on display 108 at position P0 (x0, y0) with the stereoscopic amount being value V3. Referring to FIG. 14(b), when CPU 101 determines that 25% of data D1 has been transmitted after three-dimensionally displaying object 30 on display 108 at position P0 (x0, y0) with the stereoscopic amount being value V3, CPU 101 three-dimensionally displays object 30 on display 108 at position P1 (x1, y0) with the stereoscopic amount being value V2.

Referring to FIG. 14(c), when CPU 101 determines that 50% of data D1 has been transmitted after three-dimensionally displaying object 30 on display 108 at position P1 (x1, y0) with the stereoscopic amount being value V2, CPU 101 three-dimensionally displays object 30 on display 108 at position P2 (x2, y0) with the stereoscopic amount being value V1. Referring to FIG. 14(d), when CPU 101 determines that 75% of data D1 has been transmitted after three-dimensionally displaying object 30 on display 108 at position P2 (x2, y0) with the stereoscopic amount being value V1, CPU 101 two-dimensionally displays object 30 on display 108 at position P3 (x3, y0). Further, when the transmission of data D1 has been completed, CPU 101 stops displaying object 30.

As described above, CPU 101 changes the display manner of object 30 from the three-dimensional display to the two-dimensional display with passage of time after starting the transmission of data D1. Further, during the three-dimensional display, CPU 101 gradually decreases the stereoscopic amount of object 30 with passage of time. Further, CPU 101 changes the display manner of the object while moving the display position of object 30 on display 108 in one direction.

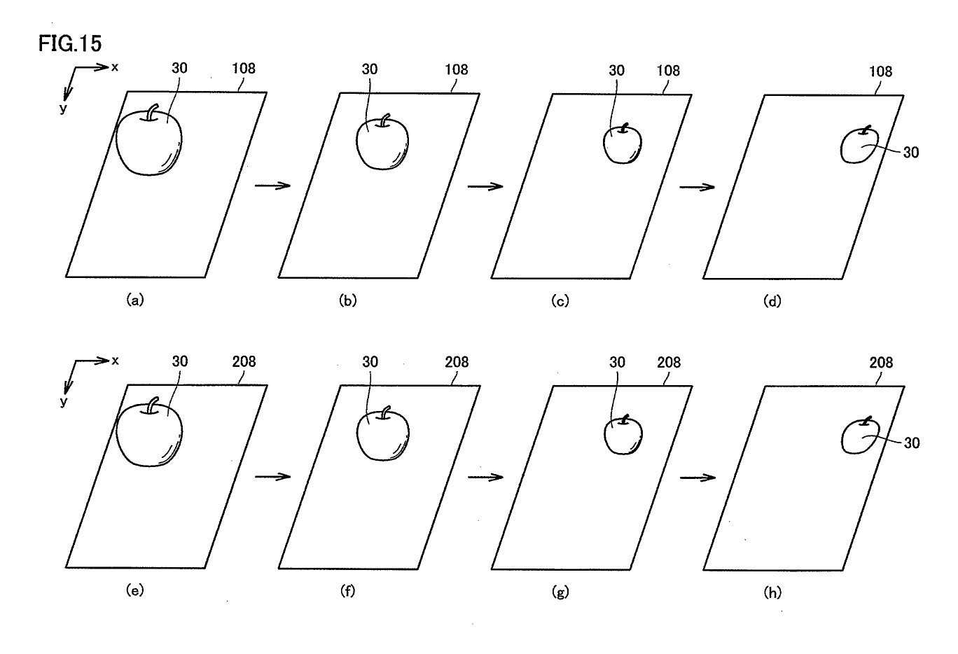

FIG. 15 shows a fourth example of screen transition in the variation. FIGS. 15(a), (b), (c), and (d) are respectively the same as FIGS. 14(a), (b), (c), and (d). FIGS. 15(e), (f), (g), and (h) are respectively the same as FIGS. 12(e), (f), (g), and (h).

In other words, CPU 101 changes the display manner of object 30 from the three-dimensional display to the two-dimensional display with passage of time after starting the transmission of data D1. Further, during the three-dimensional display, CPU 101 gradually decreases the stereoscopic amount of object 30 with passage of time. Further, CPU 101 changes the display manner of the object while moving the display position of object 30 on display 108 in one direction.

Further, CPU 201 changes the display manner of object 30 from the three-dimensional display to the two-dimensional display with passage of time during reception of data D1. Further, during the three-dimensional display, CPU 101 gradually decreases the stereoscopic amount of object 30 with passage of time. Further, CPU 201 changes the display manner of the object while moving the display position of object 30 on display 208 in one direction.

It should be noted that the moving direction of object 30 in each of communication device 10 and communication device 20 is not limited to the positive direction on the x axis. The moving direction of object 30 may be, for example, the negative direction on the x axis, the positive direction on the y axis, or the negative direction on the y axis.

Further, different moving directions of object 30 may be set in advance for a case where the communication device serves as a communication device that transmits data D1 and a case where the communication device serves as a communication device that receives data D1.

(Variation of Object)

The description above has illustrated the configuration in which image data D2 indicating object 30 is transmitted from communication device 10 to communication device 20 and object 30 is displayed on communication device 20 based on image data D2 thus received. However, image data D2 indicating object 30 does not necessarily need to be transmitted from communication device 10 to communication device 20.

For example, each of communication device 10 and communication device 20 may have an object stored in each of flash memory 104, 204 in advance as default, and the object thus stored in advance may be designated to be displayed instead of object 30. It should be noted that communication device 10 and communication device 20 may have the same or different object(s) stored in advance.

Further, object 30 does not necessarily need to be associated with the indication of data D1.

(Variation of Communication System)

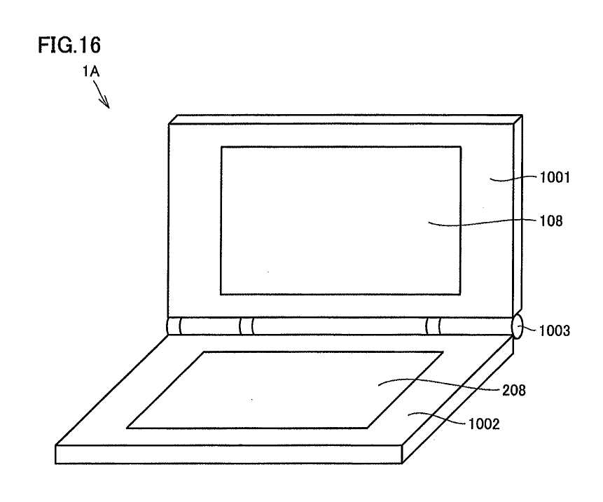

FIG. 16 shows a variation of a communication system 1. Referring to FIG. 16, a communication system 1A is a terminal having two screens. Communication system 1A includes a first housing 1001, a second housing 1002, and a hinge 1003. First housing 1001 is connected to second housing 1002 via hinge 1003 in an openable/closable manner.

First housing 1001 includes communication device 10. Display 108 of communication device 10 is exposed on a surface of first housing 1001. Second housing 1002 includes communication device 20. Display 208 of communication device 20 is exposed on a surface of second housing 1002. When communication system 1A is folded, display 108 and display 208 face each other.

Also in communication system 1A, the same process as that in communication system 1 can be performed.

<Appendix>

Communication device 10 may have the following configuration: (1) a configuration in which when starting transmission of data, an object is displayed in one display manner of the two-dimensional display and the three-dimensional display, and then the display manner of the object is changed to the other display manner; or (2) a configuration in which when starting transmission of data, an object currently displayed in one display manner of the two-dimensional display and the three-dimensional display is changed to the other display manner. In this case, during the three-dimensional display, communication device 10 preferably changes the stereoscopic amount of the object on display 108 with passage of time.

Communication device 20 may be configured such that when receiving data, an object is displayed in one display manner of the two-dimensional display and the three-dimensional display and then the display manner of the object is changed to the other display manner. In this case, during the three-dimensional display, communication device 20 preferably changes the stereoscopic amount of the object on display 208 with passage of time.

The embodiments disclosed herein are illustrative and is not limited to the description above. The scope of the present invention is defined by the terms of the claims, and is intended to include any modifications within the scope and meaning equivalent to the terms of the claims.

### REFERENCE SIGNS LIST

1, 1A: communication system; 10, 20: communication device; 30: object; 104, 204: flash memory; 106, 206: communication IF; 108, 208: display.

1. A transmitter comprising a processor, a memory connected to the processor, a display, and a communication interface,
transmission data and image data for displaying an object being stored in said memory,
said image data including right-eye image data and left-eye image data for three-dimensionally displaying said object,
when receiving a command for transmitting said transmission data, said processor starting a process to transmit said transmission data to a receiver using said communication interface,
when starting said process, said processor displaying said object on said display based on said image data in predetermined one display manner of two-dimensional display and three-dimensional display,
after displaying said object in said one display manner, said processor displaying said object on said display in a different display manner of said two-dimensional display and said three-dimensional display than said one display manner.

2. A transmitter comprising a processor, a memory connected to the processor, a display, and a communication interface,
transmission data and image data for displaying an object being stored in said memory,
said image data including right-eye image data and left-eye image data for three-dimensionally displaying said object,
said processor displaying said object on said display based on said image data in predetermined one display manner of two-dimensional display and three-dimensional display,
when receiving a command for transmitting said transmission data with said object being displayed on said display, said processor starting a process to transmit said transmission data to a receiver using said communication interface,
when starting said process, said processor displaying said object on said display in a different display manner of said two-dimensional display and said three-dimensional display than said one display manner.

3. The transmitter according to claim 1, wherein during said three-dimensional display, said processor changes a stereoscopic amount of said object on said display with passage of time.

4. The transmitter according to claim 2, wherein during said three-dimensional display, said processor changes a stereoscopic amount of said object on said display with passage of time.

5. The transmitter according to claim 3, wherein:
said predetermined one display manner is said two-dimensional display; and
said processor increases the stereoscopic amount of said object with passage of time.

6. The transmitter according to claim 4, wherein:
said predetermined one display manner is said two-dimensional display; and
said processor increases the stereoscopic amount of said object with passage of time.

7. The transmitter according to claim 3, wherein:
said predetermined one display manner is said three-dimensional display; and
said processor decreases the stereoscopic amount of said object with passage of time.

8. The transmitter according to claim 4, wherein:
said predetermined one display manner is said three-dimensional display; and
said processor decreases the stereoscopic amount of said object with passage of time.

9. The transmitter according to claim 3, wherein said processor further transmits said image data to said receiver.

10. The transmitter according to claim 4, wherein said processor further transmits said image data to said receiver.

11. The transmitter according to claim 3, wherein when starting the process to transmit said transmission data to said receiver, said processor changes the stereoscopic amount of said object while moving said object in a predetermined direction.

12. The transmitter according to claim 4, wherein when starting the process to transmit said transmission data to said receiver, said processor changes the stereoscopic amount of said object while moving said object in a predetermined direction.

13. The transmitter according to claim 1, wherein when the transmission of said transmission data is completed, said processor stops displaying said object.

14. The transmitter according to claim 2, wherein when the transmission of said transmission data is completed, said processor stops displaying said object.

15. A receiver comprising a processor, a memory connected to the processor, a display, and a communication interface,
said processor receiving transmission data, which is transmitted from a transmitter, using said communication interface,
when starting to receive said transmission data, said processor displaying an object on said display in predetermined one display manner of two-dimensional display and three-dimensional display based on image data stored in said memory and including right-eye image data and left-eye image data,
after displaying said object in said one display manner, said processor displaying said object on said display in a different display manner of said two-dimensional display and said three-dimensional display than said one display manner.

16. The receiver according to claim 15, wherein during said three-dimensional display, said processor changes a stereoscopic amount of said object on said display with passage of time.

17. The receiver according to claim 16, wherein:
said predetermined one display manner is said three-dimensional display; and
said processor decreases the stereoscopic amount of said object with passage of time.

18. The receiver according to claim 16, wherein:
said predetermined one display manner is said two-dimensional display; and
said processor increases the stereoscopic amount of said object with passage of time.

19. The receiver according to claim 16, wherein said processor further receives said image data from said transmitter and stores the received image data in said memory.

20. (canceled)

21. The receiver according to claim 16, wherein when receiving said transmission data from said transmitter, said processor changes the stereoscopic amount of said object while moving said object in a predetermined direction.

22-37. (canceled)
